(19) United States
(12) Patent Application Publication
(10) Pub. No.: US 2024/0192005 A1
(43) Pub. Date: Jun. 13, 2024

(54) DEVICE AND METHOD FOR PREDICTING A PATH TAKEN BY A VEHICLE FOR A TRANSPORT TASK

(71) Applicant: GRABTAXI HOLDINGS PTE. LTD., Singapore (SG)

(72) Inventors: Suwei YANG, Singapore (SG); Chen LIANG, Singapore (SG); Kuldeep Singh MEEL, Singapore (SG)

(21) Appl. No.: 18/556,470

(22) PCT Filed: Jun. 27, 2022
(86) PCT No.: PCT/SG2022/050436

§ 371 Date: Oct. 20, 2023

(30) Foreign Application Priority Data
Jun. 30, 2021 (SG) 10202107193Y

(51) Int. Cl. G01C 21/34; G06Q 10/04; G06Q 50/47

(52) U.S. Cl. CPC G01C 21/3484; G06Q 10/04; G06Q 50/47

(57) ABSTRACT

Aspects concern a method for predicting a path taken by a vehicle for a transport task comprising obtaining training data specifying paths taken, representing a set of valid paths as a Boolean formula, converting the Boolean formula into an OBBD[Λ] comprising, for each variable of a set of variables on which the Boolean formula operates, a decision node representing the variable, wherein the decision node has, for each assignment of a value to the variable represented by the decision node, an outgoing edge associated with the value, augmenting each outgoing edge of each decision node with a probability depending on the number of times the location represented by the decision node was visited in the paths specified by the training data elements and predicting a path for a given transport task by sampling an assignment of values to the variables by traversing the OBBD[Λ].

### TECHNICAL FIELD

Various aspects of this disclosure relate to devices and methods for predicting a path taken by a vehicle for a transport task.

### BACKGROUND

Predicting the route a vehicle takes for a trip is a task which finds several applications in real-world scenarios, from optimizing the efficiency of vehicle dispatching systems to predicting and reducing traffic jams. In particular, it is of interest in context of e-hailing, which, thanks to the advance of smartphone technology, has become popular globally and enables customers to hail taxis using their smartphones.

Correctly predicting a route a driver takes for a trip (i.e. for serving a customer of the e-hailing service) for example allows the e-hailing server to estimate the time the trip will take and thus, at which time the driver will be free for serving another customer, i.e. the time at which the server may re-allocate the driver to another transport task, i.e. another trip. The better the route can be predicted, the better the estimation of the arrival time can be expected to be (assuming that information like traffic information is available, which may in turn be estimated by prediction of trips taken by vehicles).

Accordingly, efficient methods for predicting routes taken for trips are desirable.

### SUMMARY

Various embodiments concern a method for predicting a path taken by a vehicle for a transport task comprising obtaining training data comprising a multiplicity of training data elements, wherein each training data element specifies a path taken in a location network, representing a set of valid paths as a Boolean formula operating on a set of variables, wherein each location of the location network is represented by a variable of the set of variables and the output of the Boolean formula for an assignment of values to the variables indicates whether the assignment of values to the variables represents a valid path through the road network, converting the Boolean formula into an ordered binary decision diagram augmented with conjunction nodes comprising, for each variable of the set of variables, a decision node representing the variable, wherein the decision node has, for each assignment of a value to the variable represented by the decision node, an outgoing edge associated with the value, augmenting each outgoing edge of each decision node with a probability depending on the number of times the location represented by the decision node was visited in the paths specified by the training data elements and predicting a path for a given transport task by sampling an assignment of values to the variables by traversing the ordered binary decision diagram augmented with conjunction nodes wherein at each decision node, an assignment of a value to the variable represented by the decision node is selected with the probability of the outgoing edge associated with the value if the assignment of the value to the variable leads to a valid path which is in line with the transport task.

According to one embodiment, comprising calculating the probability of a path by traversing the ordered binary decision diagram augmented with conjunction nodes in a layer-wise manner.

According to one embodiment, predicting the path comprises determining an output assignment for each node of the ordered binary decision diagram augmented with conjunction nodes, wherein each output assignment specifies a partial assignment of values to the variables of the Boolean formula.

According to one embodiment, determining the output assignment at a conjunction node comprises combining the assignments output by the child nodes of the conjunction node.

According to one embodiment, determining the output assignment at a decision node comprises combining the assignment output of the child node of the outgoing branch corresponding to the selected assignment of the variable represented by the decision node with the selected assignment of the variable represented by the decision node.

According to one embodiment, predicting the path comprises processing the ordered binary decision diagram augmented with conjunction nodes in layers, wherein the nodes in a layer are not children or parents of nodes of the other layers.

According to one embodiment, predicting the path comprises generating, for each layer, a decision node matrix which has a column for each decision node containing the probabilities of the outgoing edges of the decision node and comprises generating, for each layer, a conjunction node matrix which has a column for each conjunction node containing identifications of child nodes of the conjunction node and processing the decision node matrix and the conjunction matrix.

According to one embodiment, the transport task specifies a departure location and a destination location and wherein a valid path is in line with the transport task is it connects the departure location with the destination location within the location network.

According to one embodiment, the set of variables is a first set of variables and the Boolean formula further operates on a second set of variables, wherein each location of the location network is associated with a respective variable of the second set of variables whose value indicates, for a path, whether the location is an end location of the path.

According to one embodiment, the output of the Boolean formula only indicates for a path that it is a valid path if it contains at least one end location.

According to one embodiment, the output of the Boolean formula only indicates for a path that it is a valid path if it contains at most two end locations.

According to one embodiment, the output of the Boolean formula indicates for a path that it is a valid path even if the path contains a main path comprising at least one end location and one or more loops in addition to the main path which do not contain nodes adjacent to the nodes of the path. According to one embodiment, each location is a geographical area corresponding to a geohash of a predetermined level (e.g. a level 5 geohash) or corresponds to an OSM (OpenStreetMap) node.

According to one embodiment, in an assignment of the variables, each variable is assigned true of the location represented by the variable is part of a path represented by the assignment or false if the location represented by the variable is not part of the path represented by the assignment.

According to one embodiment, a server computer comprising a radio interface, a memory interface and a processing unit is provided configured to perform the method for predicting a path taken by a vehicle for a transport task described above.

According to one embodiment, a computer program element is provided comprising program instructions, which, when executed by one or more processors, cause the one or more processors to perform the method for predicting a path taken by a vehicle for a transport task described above.

According to one embodiment, a computer-readable medium is provided comprising program instructions, which, when executed by one or more processors, cause the one or more processors to perform the method for predicting a path taken by a vehicle for a transport task described above.

### BRIEF DESCRIPTION OF THE DRAWINGS

The invention will be better understood with reference to the detailed description when considered in conjunction with the non-limiting examples and the accompanying drawings, in which:

FIG. 1 shows a smartphone.

FIG. 2 shows a flow diagram for predicting a route.

FIG. 3 shows an ordered binary decision diagram augmented with conjunction nodes.

FIG. 4 shows a flow diagram illustrating a method for predicting a path taken by a vehicle for a transport task.

FIG. 5 shows a server computer according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

An e-hailing app, typically used on a smartphone, allows its user to hail a taxi (or also a private driver) through his or her smartphone for a trip.

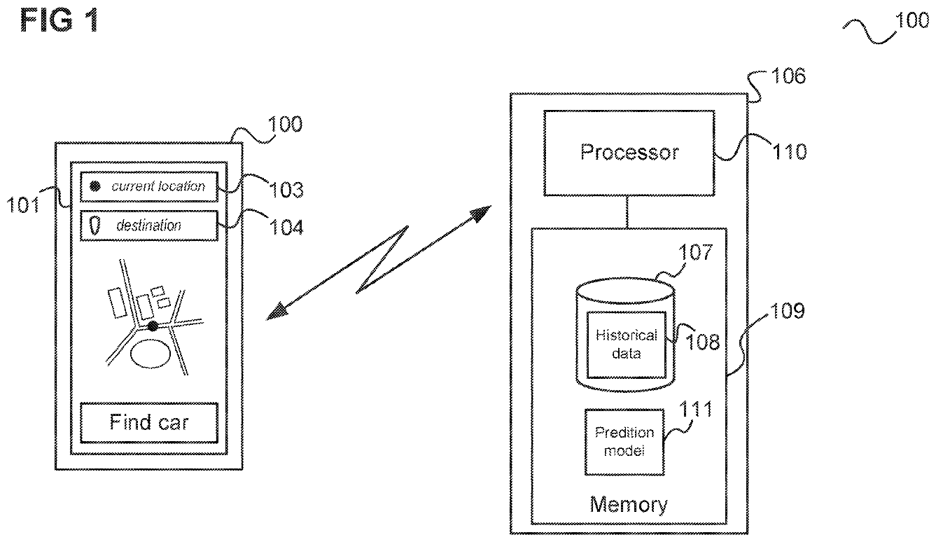

FIG. 1 shows a smartphone 100.

The smartphone 100 has a screen showing the graphical user interface (GUI) of an e-hailing app that the smartphone's user has previously installed on his smartphone and has opened (i.e. started) to e-hail a ride (taxi or private driver).

The GUI 101 includes a map 102 of the user's vicinity (which the app may determine based on a location service, e.g. a GPS-based location service). Further, the GUI 101 includes a field for point of departure 103 (which may be set to the user's present location obtained from location service) and a field for destination 104 which the user may touch to enter a destination (e.g. opening a list of possible destinations). There may also be a menu (not shown) allowing the user to select various options, e.g. how to pay (cash, credit card, credit balance of the e-hailing service). When the user has selected a destination and made any necessary option selections, he or she may touch a “find car” button 105 to initiate searching of a suitable car for the trip between the user's location and the selected destination, i.e. to request a trip between the user's location and the selected destination.

For this, the e-hailing app communicates with a server 106 of the e-hailing service via a radio connection. The server 106 includes a database (e.g. database 107) storing the current location of registered drivers, when they are expected to be free, has information about traffic jams etc. From this information, a processor 110 of the server 106 determines the most suitable driver (if available) and provides a estimate of the time when the driver will be there to pick up the user, a price of the ride and how long it will take to get to the destination. The server communicates this back to the smartphone 100 and the smartphone 100 displays this information on the GUI 101. The user may then accept (i.e. book) by touching a corresponding button.

To determine the most suitable driver and an estimate of the time when the driver will be there to pick up the user, a price of the ride and how long it will take to get to the destination, the server 106 may have a memory 109 storing a trained route prediction model 111 which the processor 110 may run to predict a route that will be taken for the ride by a respective driver allocated to the requested trip. The server 106 may also use the time to estimate the time a driver will take to arrive at the user's location for pickup. The server 106 may also estimate traffic by using the model 111 to predict the routes taken by other vehicles and estimate travelling times based on the estimated traffic.

For training the model 111, the data base 107 stores map data (i.e. location network data) and historical trip data 108 specifying routes taken between a respective point of departure and destination. The server 106 may for example gather this information by recording information about routes taken by drivers of the e-hailing service.

The data base 107 is in this example implemented by the local memory 109 of the server computer 106. However, it may also be implemented at least partially externally to the server computer 106, e.g. in a cloud. It should be noted while the server 106 is described as a single server, its functionality, e.g. for providing an e-hailing service for a whole city, will in practical application typically be provided by an arrangement of multiple server computers (e.g. implementing a cloud service). Accordingly, the functionality described in the following provided by the server 106 may be understood to be provided by an arrangement of servers or server computers.

The task of predicting a route taken by a driver between a point of departure (e.g. customers location or current location of the driver) and a destination (e.g. customers desired destination or customer's location for pickup, respectively) may also be seen as popular route mining, i.e. the task of finding popular routes on a map (given a point of departure “location A” and a point of arrival “location B”).

According to various embodiments, the task of finding popular routes on a map from location A to location B is formulated as a sampling problem. A popular route (and thus e.g. predicted route) is then a route with high probability, in a distribution of all possible routes between location A and location B.

According to various embodiments, locations are represented by nodes of a graph. They may correspond to points of interest on a map and/or road segments of a road network (e.g. given by map data stored in the memory 107. In the embodiment described in the following, level 5 geohashes are used for nodes of the graph, but the approaches described in the following work on various levels of detail. For example, the open street map road network may be used as a basis for the nodes of the graph. A location may be a starting location of a trip (i.e. point of departure), an end location of a trip (i.e. destination) or a point via which the route goes (i.e. a via-point).

In the embodiments described in the following, a probability distribution is included over the space of all valid paths (through the graph), and the probabilities of routes are learnt from training data, e.g. the historical trip data.

In the following embodiments, an OBDD[∧] is used as a graph to represent locations and whether combinations of locations form valid routes. OBBD[∧] is an augmentation of OBDD (Ordered Binary Decision Diagram) with conjunctive decomposition, i.e. an OBDD which includes conjunctions.

A sampling algorithm is provided which allows getting a route (or path) in one go, rather than in an iterative manner, although both is possible for the OBBD[∧] representation. The OBBD[∧] is augmented with probabilities which are learnt from the training data and which allow determining (sampling) popular routes, i.e. to predict a route taken between two given locations. Approaches are described in the following which allow to calculate the probability of a route (according to the learnt distribution of routes) and to sample a route based on the learnt route probabilities. According to various embodiments, matrix multiplication is used to calculate probabilities and to sample routes.

To get popular routes, they can be sampled from the route distribution learnt from the training data, wherein geohash level 5 areas as nodes (i.e. locations) are for example used such that popular routes that are sampled are also sufficiently different. For example, it can thus be achieved that different sampled routes not only differ by one or two turns, but rather significantly, for example taking a different express way. By using geohash level 5 nodes, sampling for different routes is implicitly done based on a geohash level 5 path distribution. If the routes are different on a high level abstraction, then they can be expected to be different on road network level.

The approaches described in the following allow
Learning a distribution of elements (routes in the present use case) that can be described by a Conjunctive Normal Form Boolean representation
Calculating a probability of a certain route occurring in a space of all routes
Weighted sampling of a route, based on weights (probability parameters learnt)
Sampling routes from map from point A to B, calculating probability of route
Determining which path the driver is most likely to take, and predicting ETA (estimated time of arrival) and ETT (estimated travel time)
Analyze general traffic patterns, since popular routes can be determined, divert drivers

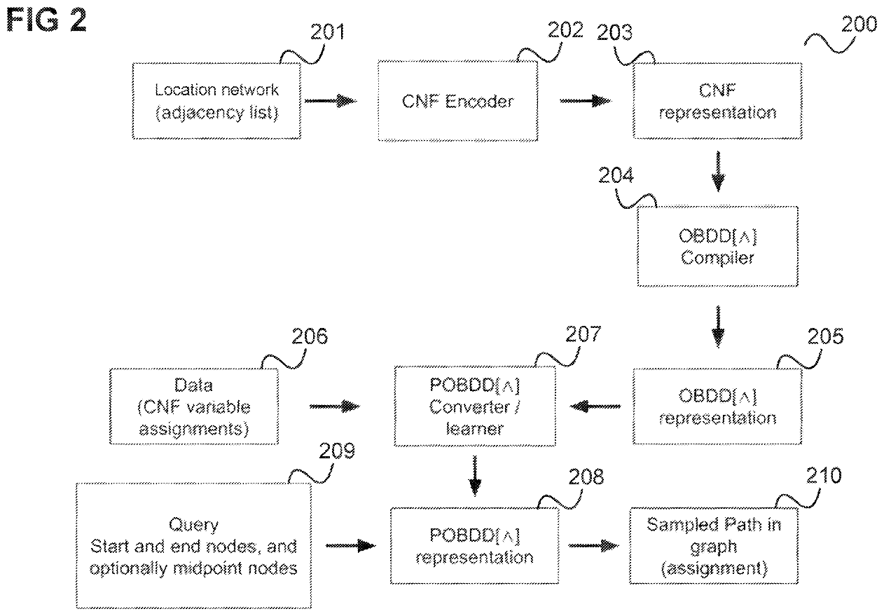

FIG. 2 shows a flow diagram 200 for predicting a route.

A location network 201 is used as an input. This may be a list of geohash level 5 nodes and the information which geohash level 5 nodes are adjacent (e.g. as adjacency list). The location network 201 may also be given in form of a road network which specifies locations and road segments (i.e. edges) connecting the locations.

A CNF (Conjunctive Normal Form) encoder 202 brings the location network 201 into a CNF representation 202. The CNF representation is a Boolean formula (or Boolean function) which is true for all combination of locations (including locations being specified as endpoints) of the location network 201 which contain a valid route (also referred to as path) and wrong for all combination of locations of the location network 201 which do not contain a valid path. This means that the output of the Boolean formula for an input assignment of values to variables indicates whether this assignment of variables (and thus of locations to a path) gives a valid path. A path may for example be invalid if it has gaps, i.e. lacks via-points between nodes which are part of the combination but which are not adjacent or if does have more than two endpoints.

An OBBD[∧] compiler 204 brings the CNF into the form of an OBBD[∧], i.e. generates an OBBD[∧] representation 205 for the CNF. OBBD[∧] compilers are available tools and an existing OBBD[∧] compiler may be used.

Training data (i.e. valid routes, wherein each is given by a combination of locations, i.e. allocation of locations to routes) 206 is used by a POBDD[∧] converter 207 (carrying out a learning or training method) to include probability information into the OBDD[∧] and thus generate a POBDD[∧] representation 208.

For predicting a route, a corresponding query 209 (for example specifying as parameters the starting location and the end location of the route and possibly one or more midpoint locations of the routes via which the route should go) may be answered by the POBDD[∧] which outputs a sampled path 210 (i.e. a prediction) or multiple sampled paths (e.g. the k most popular paths fulfilling the parameters of the query 209).

As mentioned above, the CNF representation is a Boolean formula which is true for all combination of locations (including locations being specified as endpoints) of the location network 201 which form a valid path and wrong for all combination of locations of the location network 201 that do not form a valid path.

For this, two sets of variables, n variables and s variables are used. Each location (or location network vertex) has one associated n variable and one associated s variable. Each path is given (i.e. encoded) by an assignment of values to the variables. When an n variable is set to true (according to the assignment of a path), it means the path includes the associated location, and false otherwise. When an s variable is set to true (according to the assignment of a path), it means that the associated location is a terminating location of the path i.e. the vertex is a start or destination of the path.

The CNF representation is true for an assignment (i.e. for a path) if the following is fulfilled:
1. For each vertex i, if sᵢ is true, then nᵢ is true and at most one adjacent vertex of i must be true
2. At most two s variables are true out of all s variables
3. At least one s variable is true out of all s variables
4. For each vertex i, if nᵢ is true then at least 1 of its adjacent vertices n is true
5. For each vertex i, if nᵢ is true and one of nⱼ is true for all nⱼ of adjacent vertex of i, then either exactly one more nₖ must be true where k≠j and k in adjacent vertex set of i OR sᵢ must be true.

Any assignment of all variables, including both n and s type variables, that satisfies all the above conditions contains a valid path.

In a query 209, the s variables for start and end vertex (and possible midpoints) are set to be true.

The CNF representation 203 can be seen as an approximate encoding of all valid paths because although every assignment that satisfies all the above conditions will contain a path from start to end vertex, there might be additional disjoint loops in the assignment. These, however, can be very easily cleaned by performing a depth first traversal from the start or end vertex.

It should be noted that the number of variables in CNF scales linearly with the number of vertices (locations) in the location network, and the depth of the constructed OBDD[∧] representation 205 has as upper bound the number of variables in the CNF representation 203. This ensures that it is possible to calculate probabilities and sample assignments quickly.

For training, each historical trip (which is a training data element) of the trip data (training data) 108 is converted into an assignment variables according to the CNF encoding. This means that the n variable of locations which occur in the trip are set to True and the s variable of the locations which are the end locations (point of departure and destination) are set to True (all other variables are set to False). So, the trips are described as an assignment of the variables which are used in the CNF representation 203 and the CNF outputs True for the historical trips because they are valid paths. The training data is used to set (or update) the POBDD[∧] probability parameters (i.e. the probability values of the POBDD[∧] representation 208). The POBDD[∧] representation 208 can be seen as an OBDD[∧] which is augmented with probabilities.

OBDD[∧] and POBDD[∧] are directed acyclic graphs (DAGs), with four types of nodes: True node, False node, conjunction node (also known as AND node) and decision node (also known as OR node). A decision node has two children nodes, referred to as low (or ‘lo’) child and high (or ‘hi’) child. The leaf nodes can only be either a True node or False node. True node and False node do not have child nodes. The DAG's root node is usually either a conjunction node or a decision node.

OBDD stands for Ordered Binary Decision Diagram. It allows representing a Boolean formula by means of a DAG, wherein each node (except for the leaves) is a decision node and represents a variable occurring in the Boolean formula. The leaves are, as mentioned above, True or False nodes. The Boolean formula represented by an OBDD for an input assignment of the variables can be evaluated by starting at the root and, at each node, proceeding to the low child if the variable represented by the node is False and proceeding to the high child if the variable represented by the node is True until one arrives at a leaf. The value of the leaf node—True or False—gives the value (i.e. output) of the Boolean formula for that assignment.

An OBDD[∧] further comprises conjunction nodes. At a conjunction node, the results of the Boolean formulas represented by the sub-diagrams having the child nodes of the conjunction nodes as roots, are combined according to a logical AND.

Starting at the root node for a given assignment thus gives a validity output (True or False) for the assignment. Similarly, each node gives a validity output by, instead of starting from the root node, starting from that node and traversing the graph according to the assignment.

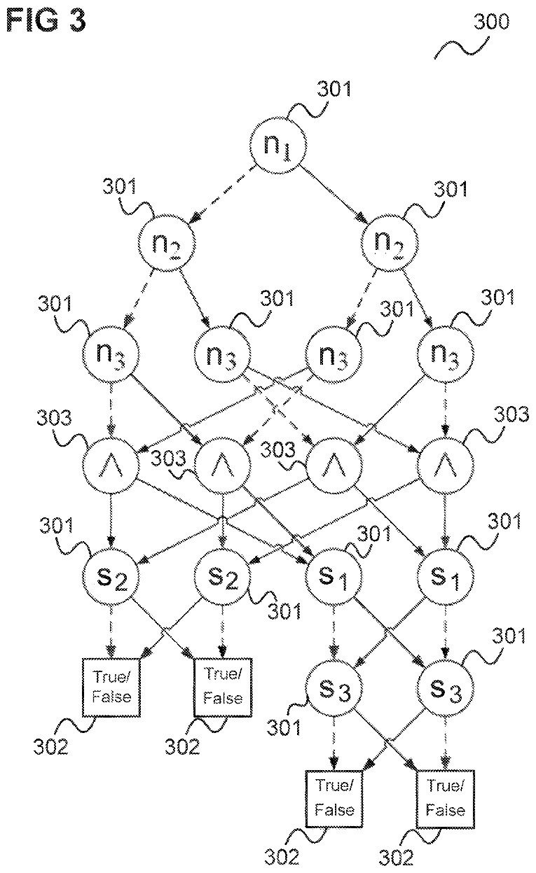

FIG. 3 shows an OBDD[∧] 300, i.e. an ordered binary decision diagram augmented with conjunction nodes.

As explained above, a decision node 301 is associated with a Boolean variable in the CNF representation 203 and the child nodes of the decision nodes 301 can be seen as decisions on the Boolean variable (high child for the case that the decision node's variable is set to true and low child for the case that the decision node's variable is set to false).

In this simple example, the OBDD[∧] comprises decision nodes 301, representing, and thus, labelled with, n variables n₁ to n₆. The OBDD[∧] further comprises leaf nodes 302 and conjunction nodes 303. A conjunction node 303 has a least one child node whereas a decision node 301 has exactly two children nodes.

There are three properties that OBDD[∧] (and by implication POBDD[∧]) has which play a role for the following approaches. The properties are decomposability, determinism and smoothness.

Decomposability takes place at conjunction nodes 303. A conjunction node 303 is decomposable if the nodes of its child sub-diagrams, that means sub-diagrams that have its child nodes as root nodes, all represent disjoint sets of Boolean variables. A conjunction node can be viewed as splitting the features that make up the space of all scenarios into disjoint sets of features. This allows decomposing the Boolean formula represented into smaller formulas that do not share variables.

Determinism happens at decision nodes 301. A decision node 301 holds the determinism property if the two sub-diagrams associated with each of its child nodes are logically contradictory, in other words mutually exclusive. This is clear because a Boolean variable can either be assigned true or false but not both.

The last property is smoothness. An OBDD[∧] or POBDD[∧] is said to be smooth for each and every decision node 301 within the diagram if its two children sub-diagrams have exactly the same set of Boolean variables associated with them. This means that the set of all variables in the sub-diagram (i.e. represented by the nodes of the sub-diagram) with hi-child as root is exactly the same as the set of all variables in the sub-diagram with lo-child as root.

The POBDD[∧] representation 208 is generated from the OBDD[∧] representation 205 by augmenting the edges (to its child nodes) of every decision node in the OBDD[∧] with probability parameters. The probability parameters are determined depending on the number of times that each branch is taken in the training data, with the default value being 0.5.

To learn from the historical trips as training data, each trip is, as mentioned above, converted to a sequence of level 5 geohashes and this is then converted into an assignment of the variables of the CNF representation 203 (which comprise also the variables represented by the nodes of the OBDD[∧] representation 205).

For each data training element, the POBDD[∧] converter 207 traverses the OBDD[∧] starting from the root node. At each conjunction node, it visits all the sub-diagrams with each of the children nodes as roots. At each decision node, it follows the decision (given by the training data element) on the assignment of the variable represented by the decision node, and increments a counter at the edge it has followed by 1. Once it has reached a leaf node on all the sub-diagrams that have to be traversed and has done this for all training data elements, the POBDD[∧] converter 207 normalizes the counts for each decision node and sets the probability parameters. The probability parameter at each of the two outgoing edges of a decision node can be thought of as the ratio that of the two decisions, normalized to sum to 1. The probability parameters thus represent the probability of the values of the variable associated with the decision node, conditioned on the set of traversals from the root node of POBDD[∧] that led to that particular decision node (i.e. conditioned on the set of training data elements, i.e. the historical trip data 108).

The POBDD[∧] representation 208 generated in this way be by the POBDD[∧] converter 207 can be used to calculate the probability of a given path (i.e. a given assignment of the variables). This is described in the following.

First, it should be noted that, as described above, starting at the root node for a given assignment gives a validity output (True or False) for the assignment and similarly, a validity output can also be calculated for each node (by taking the node as root node). Now, having the POBDD[∧] 208 where they are also probabilities indicated at the edges, each node may also provide a probability output for a given assignment by multiplying probabilities along the edges taken (according to the assignment) through the OBDD sub-diagrams (having child nodes of conjunction nodes as root) and multiplying the probability outputs of all children at conjunction nodes. When a variable associated with a decision node is not assigned, the output for each of the both children is evaluated, multiplied with the probability of the respective outgoing edge of the decision node and the two results are added.

In other words, the probability of an assignment (which may be partial, i.e. leave one or more variables unassigned) can be calculated in the following manner: for a decision node, its probability output would be the weighted sum of the output of its children node, with weights being the respective edge parameters. In the case where the variable of the decision node is assigned, the probability output of the decision node is the branch parameter, multiplied corresponding to the value of variable, by the probability output of the child node. For a conjunction node, its probability output is the product of the probability outputs of all of its children nodes. For a true node, its probability output is 1 and for a false node its probability output is 0. The final probability is given by the probability output of the root node of POBDD[∧].

For calculating the probability of a path (i.e. a sequence of level 5 geohashes, for example) in this manner, the POBDD[∧] 208 is pre-processed. A topological sort of the POBDD[∧] 208 is performed. This is similar to splitting the DAG structure of the POBDD[∧] 208 into layers, where the nodes in a layer do not depend on the nodes of the other layers (meaning they are not child of each other). For each layer, two matrices are created, one for the decision nodes (referred to as decision node matrix) within the layer and another for conjunction nodes (referred to as conjunction node matrix).

The decision node matrix of each layer has the shape 2×D where D is the number of decision nodes in the layer. Thus, each column of the decision node matrix corresponds to a decision node. The two values of the column are prefilled with the probability parameters for the two outgoing edges of the decision node.

The conjunction node matrix of each layer is of shape A×C where C is the number of conjunction nodes in the layer and A is the number of unique children of all the conjunction nodes in the layer. Thus, each column of the conjunction node matrix corresponds to a conjunction node and has a value for each child of the conjunction nodes of that layer.

The value corresponding to a combination of a conjunction node and a child node (by its column and row index) is set to an identification of the child node if it is a child node of the conjunction node, else it is set to 1. This matrix generation pre-processing is referred to as BuildMat.

In the following, an algorithm for calculating the probability for an input assignment T (which also be a partial assignment) is given.

Algorithm 1: returns probability of an input (partial)
assignment τ for an input POBDD[Λ] using matrices

| Input: POBDD[Λ] ψ, MatList - output of BuildMat | |
|---|---|
| algorithm, Assignment τ | |
| Output: probability of τ | |
| 1: | nodeOutput ← HashMap( ) |
| 2: | setTrueFalseProb(nodeOutput) |
| 3: | for layer l in MatList do |
| 4: | dNodes, cNodes, dMat, cMat ← splitLayerInfo(l) |
| 5: | dependentDMat ← buildDependentMat(dNodes, |
| | nodeOutput) |
| 6: | maskDMat ← getMaskDMat(dMat, τ) |
| 7: | resultDMat ← matMul(dependentDMat, maskD- |
| | Mat) |
| 8: | for decision node index d in dNodes do |
| 9: | nodeOutput[dNodes[d]] ← resultDMat[d][d] |
| 10: | fillDependent Values(cMat, nodeOutput) |
| 11: | resultCMat ← colProd(cMat) |
| 12: | for conjunction node index c in cNodes do |
| 13: | nodeOutput[cNodes[c]] ← resultCMat[1][c] |
| 14: | return nodeOutput[getRootNode(ψ)] |

Algorithm 1 processes the conjunction node matrix and the decision node matrix for each layer separately. For the decision node matrix, a dependent matrix of dimension D×2 where D is the number of decision nodes in the decision node matrix is constructed (line 5). For each decision node, the entry of the first column of the dependent matrix (in the row corresponding to the decision node) is the probability output of the lo child of the decision node of the layer. Similarly the entry of the second column is the probability output of the hi child of the decision node. This means that the probability output refers to the conditional probability output of the respective subdiagram starting at the corresponding child node.

Further, a masked version of the decision node matrix is generated (line 6) that helps to select which dependent node to take into account, based on the input assignment T. The mask matrix is element wise multiplied with the decision node matrix in getMaskDMat routine. The matrix multiplication of the dependent matrix and the masked decision node matrix gives the probability output of each decision node respectively at its diagonal entries.

As mentioned, in the conjunction node matrix, the prefilled values are the child node IDs of each conjunction node. The child node IDs values are replaced with their output during execution of the algorithm. Then the values are multiplied along the rows to get a 1×C probability output vector which represents the probability output value for each conjunction node. The output of a True node is 1 and the output of a False node is 0.

Each layer is processed in this manner and the final probability value (i.e. the probability of the input assignment) is the probability output of the root node of POBDD[∧].

In the following, it is described how a path may be sampled from the POBDD[∧] representation 208 for a query 209. The query 209 specifies a partial assignment of locations to a route (i.e. not all locations are assigned or not assigned). For this partial assignment, the probability may be calculated (according to algorithm 1) and, as described of the following, the rest of the unassigned variables may be sampled. Intuitively the sampling means that the path given by the query (i.e. given that some nodes need to be taken) is completed.

Algorithm 2 given below allows sampling a route in one bottom up pass of the POBDD[∧] representation 208 (rather than iteratively). Sampling is performed directly the POBDD[∧] for an assignment that corresponds to a path in the location network 201, conditioned upon the locations given in the query 209 (e.g. start and destination location).

Algorithm 2: returns a sample satisfying the input partial
assignment τ based on the parameters in the input POBDD[Λ]

| Input: POBDD[Λ] ψ, MatList - output of BuildMat | |
|---|---|
| algorithm, partial assignment τ | |
| Output: Complete assignment τ′ that builds on τ | |
| 1: | assignCache ← HashMap( ) |
| 2: | setTrueFalseCache(assignCache) |
| 3: | for layer l in MatList do |
| 4: | sampleVar ← uniformRandom(0,1) |
| 5: | dNodes, cNodes, dMat, cMat ← splitLayerInfo(l) |
| 6: | for decision node index d in dNodes do |
| 7: | if dNodes[d] in τ then |
| 8: | If getAssign(dNodes[d], τ) is not invalid then |
| 9: | assignCache[dNodes[d]] ← |
| | pickChild(dNodes[d], τ, assignCache) |
| 10: | else |
| 11: | assignCache[dNodes[d]] ← invalid |
| 12: | else if getLoChildCache(dNodes[d]) is invalid OR |
| | getHiChildCache(dNodes[d]) is invalid then |
| 13: | assignCache[dNodes[d]] ← |
| | pick ValidChild(dNodes[d], assignCache) |
| 14: | else |
| 15: | assignCache[dNodes[d]] ← |
| | pickSampledChild(dNodes[d], sample Var, |
| | assignCache) |
| 16: | removeInvalidNodes(cMat, cNodes, assignCache) |
| 17: | for conjunction node index c in cNodes do |
| 18: | assignCache[cNodes[c]] ← |
| | unionChildAssign(cNodes[c], assignCache) |
| 19: | τ′ ← assignCache[rootnode( )] |
| 20: | return τ′ |

In algorithm 2, an output for nodes is determined which is referred to as assignment output. An assignment output specifies a sampled (partial) assignment that is in line with the input assignment t. An assignment output may however be invalid. The determination of the assignment outputs happens in a bottom up manner such that more and more variables get assigned until the output of the root node gives a complete (sampled) assignment.

Algorithm 2 processes the POBDD[∧] layer by layer, similar to the probability calculation algorithm 1. In algorithm 2, no matrix multiplication is performed algorithm 2 makes use of the two matrices (the decision node matrix and the conjunction node matrix) created in the pre-processing matrices as mentioned above. At each layer, algorithm 2 first gets a randomly sampled value sampleVar from a uniform distribution between 0 and 1 inclusive (line 4). Next, it processes the decision node matrix and the conjunction node matrix separately.

For the decision nodes corresponding to the columns of the decision node matrix, the POBDD[∧] gives the probability parameters for the hi and to branch. Algorithm 2 first checks whether the variable for each decision node has already been given an assignment in the input assignment τ. If the variable is assigned by the input assignment then the algorithm follows that assignment. If that leads to an invalid assignment, then the assignment output of the decision node is also invalid. If the variable is not assigned by the input assignment and sampleVar is higher than the lo branch probability parameter, the variable is assigned to True, otherwise False. Next, the algorithm checks whether this assignment is valid, that is if the assignment output of the respective child, i.e. hi child or lo child output, is valid, respectively. If the assignment output of the respective child for the partial assignment is not valid, then the algorithm switches over to the other child and changes the assignment of the variable of the decision node (i.e. the variable represented by the decision node) accordingly. The assignment output of a decision node is the combination of assignment output of the child node (taken according to the assignment of the decision node) and the assignment of the variable of the decision node.

For the conjunction node matrix, algorithm 2 checks for each of the conjunction nodes whether any of their child nodes have invalid partial assignment outputs. If that is the case, the conjunction node assignment output is also invalid. Otherwise, the conjunction node output is the combination of the assignment outputs of its child nodes. A combination of assignments is an assignment which sets all the variables which are assigned by the assignments which are combined to the values given by the assignments which are combined.

The final sampled assignment of variables is the assignment output at the root node of POBDD[∧].

In summary, according to various embodiments, a method is provided as illustrated in 4.

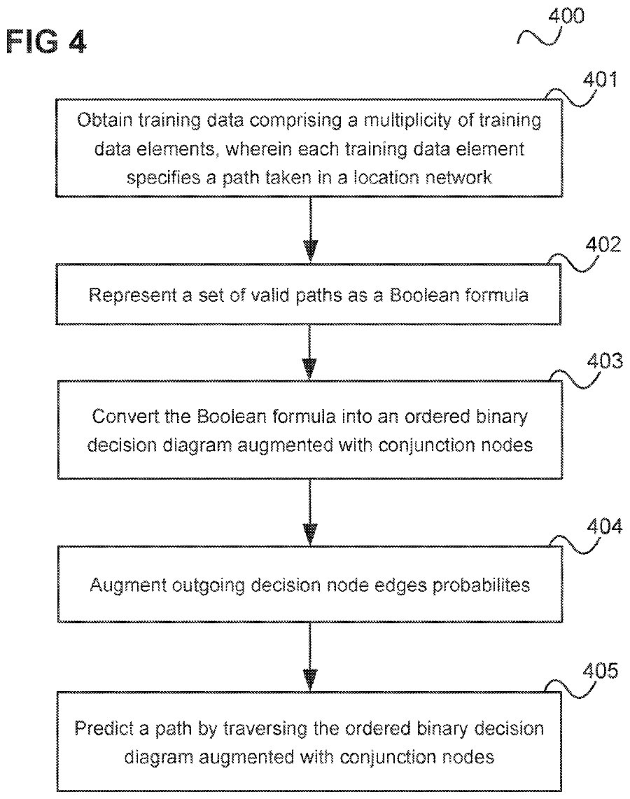

FIG. 4 shows a flow diagram illustrating a method for predicting a path taken by a vehicle for a transport task.

In 401, training data is obtained comprising a multiplicity of training data elements, wherein each training data element specifies a path taken in a location network.

In 402, a set of valid paths is represented as a Boolean formula operating on a set of variables, wherein each location of the location network is represented by a variable of the set of variables and the output of the Boolean formula for an assignment of values to the variables outputs whether the assignment of values to the variables represents a valid path through the road network.

In 403, the Boolean formula is converted into an ordered binary decision diagram augmented with conjunction nodes comprising, for each variable of the set of variables, a decision node representing the variable, wherein the decision node has, for each assignment of a value to the variable represented by the decision node, an outgoing edge associated with the value.

In 404, each outgoing edge of each decision node is augmented with a probability depending on the number of times the location represented by the decision node was visited in the paths specified by the training data elements.

In 405, a path for a given transport task is predicted by sampling an assignment of values to the variables by traversing the ordered binary decision diagram augmented with conjunction nodes wherein at each decision node, an assignment of a value to the variable represented by the decision node is selected with the probability of the outgoing edge associated with the value if the assignment of the value to the variable leads to a valid path which is in line with the transport task.

According to various embodiments, in other words, valid paths through a location network are given by those combinations of locations, for which a Boolean formula of variables (wherein each variable indicates whether a respective location is part of the path or not) gives out ‘True’ (or ‘False’, if the representation is inverted). That Boolean formula is converted into an OBDD[∧], i.e. an ordered binary decision diagram augmented with conjunction nodes, or, in other words, a structure comprising multiple OBBDs connected via one or more conjunction nodes (i.e. nodes which represent an AND combination of their child nodes). The OBDD[∧] is augmented with probabilities (i.e. outgoing branches of decision nodes are assigned probabilities) depending on the paths (and thus decisions) taken in historical trip data which serves as training data. The result, denoted as POBDD[∧] is then used for prediction: paths which fulfil a query (e.g. start location, end location and possibly intermediate locations) are sampled from the POBDD[∧] by following branches according to the probabilities which have been assigned to them.

It should be noted that a transport task may refer to the transport of persons like in an e-hailing application, but may also refer to as parcels, food, mail etc. In particular, the method may be applied in any transport network where the transport vehicles choose the paths they take autonomously. The vehicles may for example be autonomous vehicles.

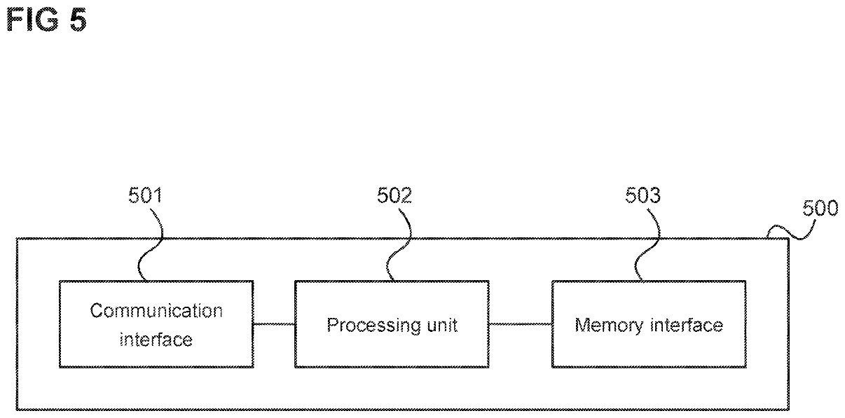

The method of FIG. 4 is for example carried out by a server computer as illustrated in FIG. 5.

FIG. 5 shows a server computer 500 according to an embodiment.

The server computer 500 includes a communication interface 501 (e.g. configured to receive queries for the prediction of a route). The server computer 500 further includes a processing unit 502 and a memory 503. The memory 503 may be used by the processing unit 502 to store, for example, historical data, i.e. training data. The server computer is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for predicting a path taken by a vehicle for a transport task comprising: obtaining training data comprising a multiplicity of training data elements, wherein each training data element specifies a path taken in a location network; representing a set of valid paths as a Boolean formula operating on a set of variables, wherein each location of the location network is represented by a variable of the set of variables and the output of the Boolean formula for an assignment of values to the variables outputs whether the assignment of values to the variables represents a valid path through the road network;
converting the Boolean formula into an ordered binary decision diagram augmented with conjunction nodes comprising, for each variable of the set of variables, a decision node representing the variable, wherein the decision node has, for each assignment of a value to the variable represented by the decision node, an outgoing edge associated with the value;
augmenting each outgoing edge of each decision node with a probability depending on the number of times the location represented by the decision node was visited in the paths specified by the training data elements; and
predicting a path for a given transport task by sampling an assignment of values to the variables by traversing the ordered binary decision diagram augmented with conjunction nodes wherein at each decision node, an assignment of a value to the variable represented by the decision node is selected with the probability of the outgoing edge associated with the value if the assignment of the value to the variable leads to a valid path which is in line with the transport task.

2. The method of claim 1, comprising calculating the probability of a path by traversing the ordered binary decision diagram augmented with conjunction nodes in a layer-wise manner.

3. The method of claim 1, wherein predicting the path comprises determining an output assignment for each node of the ordered binary decision diagram augmented with conjunction nodes, wherein each output assignment specifies a partial assignment of values to the variables of the Boolean formula.

4. The method of claim 3, wherein determining the output assignment at a conjunction node comprises combining the assignments output by the child nodes of the conjunction node.

5. The method of claim 3, wherein determining the output assignment at a decision node comprises combining the assignment output of the child node of the outgoing branch corresponding to the selected assignment of the variable represented by the decision node with the selected assignment of the variable represented by the decision node.

6. The method of claim 1, wherein predicting the path comprises processing the ordered binary decision diagram augmented with conjunction nodes in layers, wherein the nodes in a layer are not children or parents of nodes of the other layers.

7. The method of claim 6, wherein predicting the path comprises generating, for each layer, a decision node matrix which has a column for each decision node containing the probabilities of the outgoing edges of the decision node and comprises generating, for each layer, a conjunction node matrix which has a column for each conjunction node containing identifications of child nodes of the conjunction node and processing the decision node matrix and the conjunction matrix.

8. The method of claim 1, wherein the transport task specifies a departure location and a destination location and wherein a valid path is in line with the transport task is it connects the departure location with the destination location within the location network.

9. The method of claim 1, wherein the set of variables is a first set of variables and the Boolean formula further operates on a second set of variables,
wherein each location of the location network is associated with a respective variable of the second set of variables whose value indicates, for a path, whether the location is an end location of the path.

10. The method of claim 9, wherein the output of the Boolean formula only indicates for a path that it is a valid path if it contains at least one end location.

11. The method of claim 9, wherein the output of the Boolean formula only indicates for a path that it is a valid path if it contains at most two end locations.

12. The method of claim 1, wherein the output of the Boolean formula indicates for a path that it is a valid path even if the path contains a main path comprising at least one end location and one or more loops in addition to the main path which do not contain nodes adjacent to the nodes of the path.

13. The method of claim 1, wherein is a geographical area corresponding to a geohash of a predetermined level.

14. The method of claim 1, wherein, in an assignment of the variables, each variable is assigned true of the location represented by the variable is part of a path represented by the assignment or false if the location represented by the variable is not part of the path represented by the assignment.

15. A server computer comprising a radio interface, a memory interface and a processing unit configured to perform the method of claim 1.

16. A computer program element comprising program instructions, which, when executed by one or more processors, cause the one or more processors to perform the method of claim 1.

17. A computer-readable medium comprising program instructions, which, when executed by one or more processors, cause the one or more processors to perform the method of claim 1.
